(19) United States
(12) Patent Application Publication
(10) Pub. No.: US 2017/0278377 A1
(43) Pub. Date: Sep. 28, 2017

(54) METHOD AND SYSTEM FOR REAL-TIME DETECTION AND NOTIFICATION OF EVENTS

(71) Applicant: CYNDR LLC, Albuquerque, NM (US)

(72) Inventors: Jonathan FRITCH, Lancaster, CA (US); Andrei Avi STEINER-SHAKKED, Orangevale, CA (US)

(21) Appl. No.: 15/449,261

(22) Filed: Mar. 3, 2017

Related U.S. Application Data
(60) Provisional application No. 62/314,224, filed on Mar. 28, 2016.

(51) Int. Cl. G08B 21/22; G08B 21/18

(52) U.S. Cl. CPC G08B 21/22; G08B 21/182

(57) ABSTRACT

System and method for facilitating real-time detection and notification of events are disclosed. The system comprises a sensor module, a controller and a display module. The sensor module senses an occurrence of an event in proximity of a user engaged in viewing content displayed on a screen of an electronic device, and generates a signal representing the occurrence of the event. The controller determines whether a characteristic of the signal is greater than a predetermined threshold value and generates a notification if the characteristic of the signal is determined to be greater than the predetermined threshold value. The display module overlays the notification on the screen of the electronic device to alert the user of the occurrence of the event.

### TECHNICAL FIELD

The present application generally relates to notifying or alerting users of events, and more particularly to a method and system for real-time detection and notification of events.

### BACKGROUND

Typically, individuals who are engaged in viewing screens of display devices such as laptops, desktop computers, tablets, television sets or any such electronic devices for work, entertainment or any other purpose may fail to notice an event occurring in their immediate environment. For example, an individual may be oblivious to an event occurring in his or her proximity, while working on a project requiring extreme concentration. Some individuals may also find it inconvenient to turn away from the screen to view the event occurring in their respective environment. In case of individuals who are positioned within cubicles or other confined workspaces, the events occurring in their proximity may be out of a line of sight or a field of view, and as such the individuals may fail to notice the occurrence of events in their proximity. Such individuals may be in a precarious situation if the events occurring are dangerous or disruptive.

In view of the above, there is a need to detect or sense events occurring in the proximity of users engaged in viewing content on display screens and alert the users in real-time and in an effective and practical manner.

### SUMMARY

Various embodiments of the present disclosure provide systems and methods for facilitating real-time detection and notification of events.

In an embodiment, a system configured to facilitate real-time detection and notification of events is disclosed. The system includes a sensor module, a controller and a display module. The sensor module is configured to sense an occurrence of an event in proximity of a user engaged in viewing content displayed on a screen of an electronic device. The sensor module is further capable of generating a signal representing the occurrence of the event. The controller is communicably coupled with the sensor module and is configured to generate a notification if a predefined criterion related to the signal is satisfied. The display module is communicably coupled with the controller and is configured to overlay the notification on the screen of the electronic device to alert the user of the occurrence of the event.

In an embodiment, another system configured to facilitate real-time detection and notification of events is disclosed. The system includes at least one sensor, a signal converter, a controller and a display module. The at least one sensor is configured to sense an attribute in proximity of a user engaged in viewing content displayed on a screen of an electronic device. The sensing of the attribute is indicative of an occurrence of an event. The at least one sensor is further configured to generate an analog signal representing the occurrence of the event. The signal convertor is configured to convert the analog signal to a digital signal representing the occurrence of the event. The controller is configured to generate a notification if a characteristic of the digital signal exceeds a predetermined threshold value. The display module is configured to overlay the notification on a display screen to alert the user of the occurrence of the event.

In an embodiment, a method for real-time detection and notification of events is disclosed. The method senses, by a sensor module, an occurrence of an event in proximity of a user engaged in viewing content displayed on a screen of an electronic device. The method generates, by the sensor module, a signal representing the occurrence of the event. The method determines, by a controller communicably coupled with the sensor module, whether a characteristic of the signal is greater than a predetermined threshold value. The method generates, by the controller, a notification if the characteristic of the signal is determined to be greater than the predetermined threshold value. The method causes, by the controller, display of the notification on the screen of the electronic device to alert the user of the occurrence of the event.

Other aspects and example embodiments are provided in the drawings and the detailed description that follows.

### BRIEF DESCRIPTION OF THE DRAWINGS

For a more complete understanding of example embodiments of the present technology, reference is now made to the following descriptions taken in connection with the accompanying drawings in which:

FIG. 1 shows a representation of a user engaged in viewing content displayed on a screen of an electronic device, in accordance with an example scenario;

FIG. 2 is a block diagram of a system configured to facilitate real-time detection and notification of events, in accordance with an example embodiment;

FIG. 3 is a block diagram of a system configured to facilitate real-time detection and notification of events, in accordance with another example embodiment;

FIG. 4 is a block diagram showing various components of a sensor module and an electronic device for facilitating real-time detection and notification of events, in accordance with another example embodiment;

FIG. 5 shows a representation of an example notification provided to a user engaged in viewing content displayed on a screen of an electronic device, in accordance with an example embodiment;

FIG. 6 is a flow diagram of an example method for real-time detection and notification of events, in accordance with an example embodiment; and

FIG. 7 illustrates an example of an electronic device capable of implementing example embodiments described herein.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

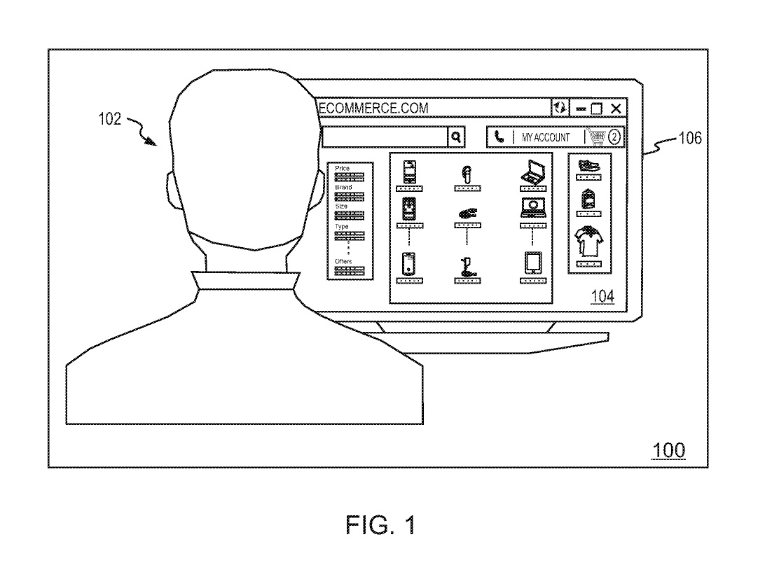

Referring now to FIG. 1, a representation 100 of a user 102 engaged in viewing content displayed on a screen 104 of an electronic device 106 is shown, in accordance with an example scenario. The screen 104 is exemplarily depicted to display content related to an e-commerce Website. It is noted that the screen 104 may display video game content, movie content, text-based content or any combination of such content for the viewing pleasure of the user 102. Furthermore, the electronic device 106 is depicted to be a desktop computer for example purposes. Some other non-exhaustive examples of the electronic device 106 include a laptop computer, a tablet computer, a mobile phone, a Smartphone, a Wearable device, a multimedia player, a Television Set, a gaming device, a Virtual Reality (VR) device, an augmented reality device, and the like. It is noted that in case of electronic devices like VR devices, the VR headsets worn by the user may include the display screen of the electronic device. Moreover, the user 102 and the electronic device 106 may be located in a home environment, an office environment, a public institution, a recreational center, and the like.

In an example scenario, the user 102 may be so engrossed in viewing the content being displayed on the screen 104, that the user 102 may be oblivious to events that occur in proximity of the user 102. The term ‘proximity’ as used herein refers to immediate surroundings of the user 102. For example, a change within a radius of few meters (for example up to five meters radius from a current location of the user 102) may be construed to be in proximity of the user 102. In an illustrative example, any change occurring within a room in which the user 102 is situated may be construed to have occurred in proximity of the user 102. Moreover, the term ‘event’ as used herein refers to a change in the immediate surroundings of the user 102. For example, if there is movement behind the user 102 or if there is a change in lighting beyond an acceptable range or if there is an object approaching the user 102, then such observation of a change from a reference position (for example, from a time the user 102 has started viewing the content on the screen 104) is construed as occurrence of an event for purposes of the description.

Generally, users engaged in viewing screens of computers, laptops, mobile devices, television sets or other display devices are oblivious to events or changes occurring in their surrounding environment. For example, the user 102 may fail to notice an intruder or an object approaching the user. In some example scenarios, the intruder may even cause harm to the user 102. In another illustrative example, a person may try to steal a password by stealthily positioning himself when the user 102 is entering a password on the electronic device 106. As such, ignoring such changes in the surrounding environment may cause irreparable harm to the user 102.

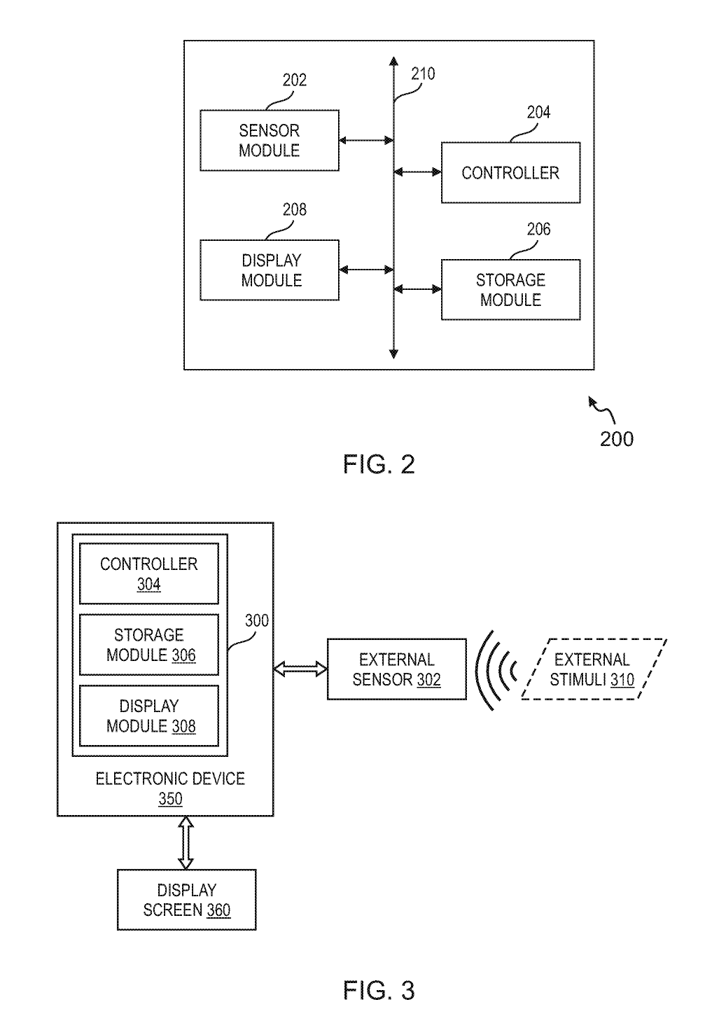

Various embodiments of the present technology provide systems and methods for facilitating real-time detection and notification of events that are capable of overcoming these and other obstacles and providing additional benefits. More specifically, the systems and methods disclosed herein monitor the user's immediate surroundings for occurrence of event(s) and alert the user if an event is detected to have occurred. The alert is provided in form of a notification that is overlaid on the screen (preferably, a screen that the user is viewing, such as the screen 104). The user, upon receiving such a notification may choose to perform an action in response to the occurrence of the event or may even ignore the notification. A system for facilitating real-time detection and notification of events is explained hereinafter with reference to FIG. 2.

FIG. 2 is a block diagram of a system 200 configured to facilitate real-time detection and notification of events, in accordance with an example embodiment. The system 200 is depicted to include a sensor module 202, a controller 204, a storage module 206, and a display module 208.

The sensor module 202 is configured to sense an occurrence of an event in proximity of a user engaged in viewing content displayed on a screen of an electronic device. As explained with reference to FIG. 1, the term ‘proximity’ refers to immediate surroundings of the user and the term ‘event’ refers to a change in the user's immediate surroundings. To sense the occurrence of the event in the proximity of the user, the sensor module 202 may include one or more sensors. Each sensor may be configured to sense an attribute in the proximity of the user. In at least one example embodiment, sensing an attribute is indicative of an occurrence of an event. For example, the sensor module 202 may include a motion sensor to sense an attribute ‘motion’ in the proximity of the user. More specifically, the motion sensor may be configured to sense movement of an object or a person in proximity of the user. Sensing motion in the proximity of the user is indicative of an occurrence of an event embodied as a movement of a person or an object in the proximity of the user. In an illustrative example, the motion sensor may be an Infrared (IR) motion sensor. In some embodiments, the sensor module 202 may include one or more sensors from among a motion sensor, a light sensor, a temperature sensor, a smoke detection sensor, a pressure sensor, an acoustic sensor, an image sensor, a humidity sensor and a chemical sensor. Various attributes, such as change in temperature, change in ambient lighting, change in ambient sound, change in pressure or humidity, change in imagery etc. may be sensed in the proximity of the user.

Further, upon sensing occurrence of an event, the sensor module 202 is capable of generating a signal representing the occurrence of the event. In at least one example embodiment, the one or more sensors within the sensor module 202 are capable of generating an analog signal representing the event. The sensor module 202 may further be configured to convert the analog signal to a digital signal representing the occurrence of the event. In an embodiment, to represent the occurrence of the event digitally, a characteristic of the digital signal may be modulated appropriately. For example, a characteristic of the digital signal such as a frequency of the digital signal or pulse-width duration of the digital signal may be adjusted so as to represent the occurrence of the event. The digital signal may then be transmitted by the sensor module 202 to the controller 204.

In an example embodiment, the sensor module 202 may be embodied as a sensing circuitry including the at least one sensor and signal circuitry for converting the sensed events into signals capable of being processed by the controller 204.

In at least one example embodiment, the controller 204 is configured to receive the signal from the sensor module 202 and generate a notification if a predefined criterion related to the signal is satisfied. In an illustrative example, a predefined criterion corresponds to the characteristic of the digital signal exceeding the predetermined threshold value. For example, if a frequency of the received digital signal is greater than a predetermined threshold frequency value or if the pulse-width duration is greater than a predetermined threshold pulse-width duration value, then the predefined criterion may be deemed to have been satisfied. Upon determining that the predefined criterion is satisfied, the controller 204 may generate a notification by using notification generation logic stored in the storage module 206. Alternatively, in some embodiments, the controller 204 may select an appropriate notification template from among a plurality of notification templates stored in the storage module 206 for generating the notification.

The controller 204 may be embodied as a multi-core processor, a single core processor, or a combination of one or more multi-core processors and one or more single core processors. For example, the controller 204 may be embodied as one or more of various processing devices, such as a coprocessor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, and the like. In an embodiment, the controller 204 may be configured to execute hard-coded functionality. In an embodiment, the controller 204 may be embodied as an executor of software instructions, wherein the software instructions may specifically configure the controller 204 to perform algorithms and/or operations described herein when the software instructions are executed.

In at least one example embodiment, the storage module 206 is configured to store platform instructions capable of being executed by the controller 204 for performing various functions of the controller 204. The storage module 206 also stores logic for comparing a characteristic of the digital signal with a predetermined threshold value. The storage module 206 may also be configured to store the predetermined threshold values for different attributes sensed by the sensors in the sensor module 202. In some example embodiments, the storage module 206 may store logic of sensing attributes for each sensor from among the one or more sensors associated with the sensor module 202.

The storage module 206 may be embodied as one or more volatile memory devices, one or more non-volatile memory devices, and/or a combination of one or more volatile memory devices and non-volatile memory devices. For example, the storage module 206 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.). As explained above, the storage module 206 may store the software instructions and algorithms for execution by the controller 204.

In at least one example embodiment, the display module 208 is configured receive the notification from the controller 204 and overlay the notification on the screen of the electronic device to alert the user of the occurrence of the event. In an embodiment, the display module 208 may include a display, such as for example a light emitting diode display, a thin-film transistor (TFT) display, a liquid crystal display, an active-matrix organic light-emitting diode (AMOLED) display, and the like. In some embodiments, the display module 208 may include circuitry to control display of remote electronic devices.

In an embodiment, various components of the system 200, such as the sensor module 202, the controller 204, the storage module 206 and the display module 208 may be configured to communicate with each other via or through a centralized circuit system 210. The centralized circuit system 210 may be various devices configured to, among other things, provide or enable communication between the components (202-208) of the system 200. In certain embodiments, the centralized circuit system 210 may be a central printed circuit board (PCB) such as a motherboard, a main board, a system board, or a logic board. The centralized circuit system 210 may also, or alternatively, include other printed circuit assemblies (PCAs) or communication channel media.

The system 200 as illustrated and hereinafter described is merely illustrative of a system that could benefit from embodiments of the invention and, therefore, should not be taken to limit the scope of the invention. In an embodiment, the system 200 may be included within or embody an electronic device, such as the electronic device 106 explained with reference to FIG. 1. It is noted that the system 200 may include fewer or more components than those depicted in FIG. 2. For example, in an embodiment, the system 200 may include only the controller 204, the storage module 206 and the display module 208. More specifically, the sensor module 202 may be embodied as an external sensor, which is communicably coupled (for example, using wireless means, wired means or through an interface means) with an electronic device comprising the controller 204, the storage module 206 and the display module 208. Such a configuration is depicted in FIG. 3.

FIG. 3 is a block diagram of a system 300 configured to facilitate real-time detection and notification of events, in accordance with another example embodiment. As explained with reference to FIG. 2, in some embodiments, a system for facilitating real-time detection and notification of events may include only a controller, a storage module and a display module. Such a system is depicted in FIG. 3 as system 300. The system 300 includes a controller 304, a storage module 306 and a display module 308. The system 300 is depicted to be housed in an electronic device 350. The controller 304, the storage module 306 and the display module 308 are similar to the controller 204, the storage module 206 and the display module 208 explained with reference to FIG. 2 and are not explained again herein. The electronic device 350 is depicted to be communicably coupled with an external sensor 302. The external sensor 302 is similar to the sensor module 202 and is not explained again herein. The external sensor 302 is configured to sense external stimuli 310, i.e., detect a change in proximity of the user and generate a signal. The signal may be converted into a digital form and transmitted to the controller 304. The controller 304 may access logic stored in the storage module 306 to determine if a predefined criterion related to the signal is satisfied or not. More specifically, the controller 304, using the logic may compare a characteristic of a received digital signal with a predetermined threshold value and determine if the predetermined threshold value is exceeded or not. If the characteristic of the digital signal exceeds the predetermined threshold value, then the predefined criterion may be determined to be satisfied and the controller 304 may be configured to generate a notification for alerting the user. The controller 304 may provision the notification to the display module 308, which may be configured to overlay the notification, or in some embodiments, render the notification on a display screen, such as a display screen 360, exemplarily depicted to be external to the electronic device 350 housing the system 300.

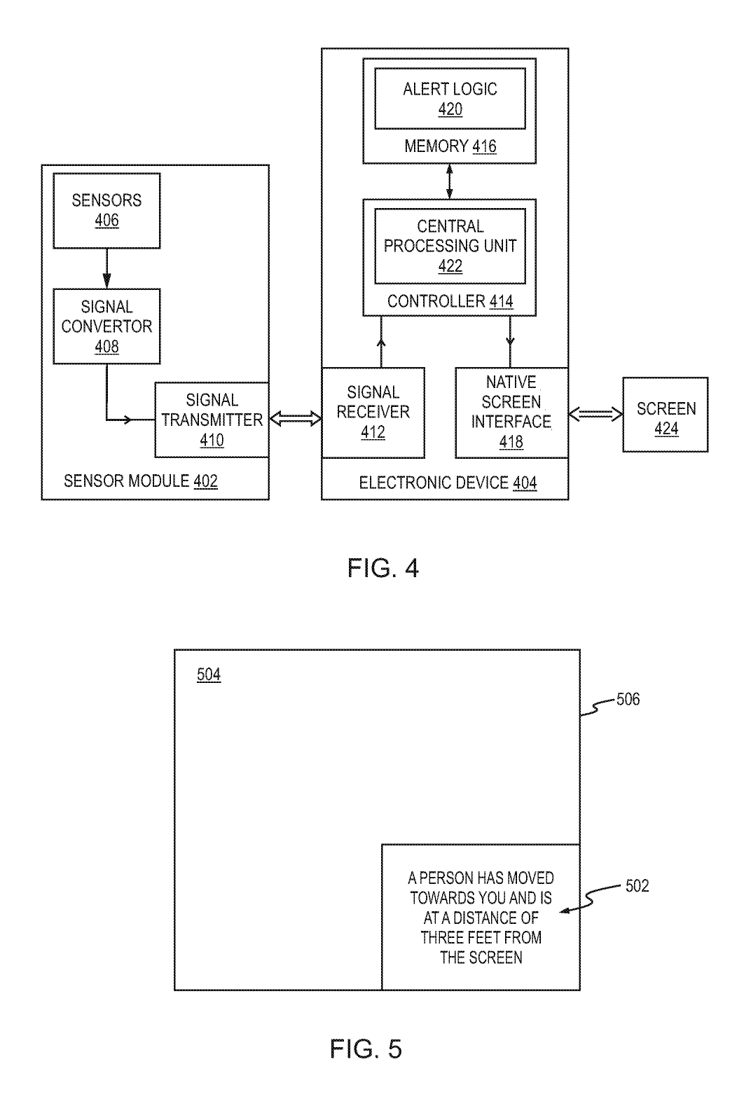

FIG. 4 is a block diagram showing various components of a sensor module 402 and an electronic device 404 for facilitating real-time detection and notification of events, in accordance with another example embodiment. It is noted that the sensor module 202 and the external sensor 302 explained with reference to FIGS. 2 and 3, respectively, may include similar internal components as will be described hereinafter with reference to the sensor module 402 for facilitating real-time sensing of occurrence of an event and generating a signal representing the sensed event.

The sensor module 402 is depicted to include a plurality of sensors 406 (depicted in FIG. 4 as ‘Sensors’ 406), a signal convertor 408 and a signal transmitter 410. Each sensor from among the plurality of sensors 406 is configured to sense attributes in the proximity of the user and generate a signal if an occurrence of an event is sensed (i.e. a change is observed in the proximity of the user). For example, the plurality of sensors 406 may include a motion sensor capable of sensing movement in the proximity of the user. Upon sensing movement such as motion of a person or an object in the proximity of the user, the motion sensor may generate an analog signal. The signal convertor 408 is configured to convert the analog signal to a digital signal representing the occurrence of the event. More specifically, a frequency or pulse-width duration of the digital signal may be configured to represent the occurrence of the event. The signal transmitter 410 may be configured to transmit the digital signal to the electronic device 404. In at least one example embodiment, the signal transmitter 410 may be configured as an USB interface. In another embodiment, the signal transmitter 410 may be configured as one of a Wi-Fi interface, a Bluetooth interface, a Zigbee interface, and the like.

The electronic device 404 is depicted to include a signal receiver 412 capable of receiving the signal transmitted by the signal transmitter 410. In at least one example embodiment, the signal receiver 412 may be configured as an USB interface. In another embodiment, the signal receiver 412 may be configured as one of a Wi-Fi interface, a Bluetooth interface, a Zigbee interface, and the like.

The electronic device 404 is further depicted to include a controller 414, a memory 416 (similar to the storage module 206) and a native screen interface 418 (similar to the display module 208). The controller 414 is configured to fetch an alert logic 420 stored in the memory 416 and determine if a characteristic of the received digital signal exceeds a predetermined threshold value or not. If the characteristic of the received digital signal exceeds the predetermined threshold value, then a Central Processing Unit (CPU) 422 included within the controller 414 is configured to generate a notification and provision the notification to the native screen interface 418. The native screen interface 418 is configured to cause display of the notification on a screen 424 for alerting the user of the occurrence of the event. In at least some embodiments, the native screen interface 418 may include a Graphics Processing Unit (GPU) for causing display of the notification on the screen 424. In an embodiment, the notification may be embodied as one of a text notification, a voice notification, an image-based notification, a video notification and a multimedia notification. In at least one embodiment, the notification may be configured to include information related to at least one of a location of a person or an object moving in the proximity of the user, a distance of the person or the object from the user, a size of the moving person or the moving object, a speed of movement of the moving person or the moving object, an acceleration associated with the movement and a direction of the movement of the moving person or the moving object.

In an illustrative example, the plurality of sensors 406 may include a smoke detection sensor configured to detect smoke in the proximity of the user. In an event of a fire, the smoke detection sensor may sense the smoke and generate an analog signal, which may then be converted into a digital form by the signal convertor 408 and transmitted by the signal transmitter 410 to the electronic device 404. The signal receiver 412 in the electronic device 404 may receive the digital signal and the controller 414 may determine if the characteristic of the digital signal exceeds a predetermined threshold value or not. If the characteristic of the digital signal exceeds a predetermined threshold value, then a notification alerting the user of detection of smoke may be generated and displayed by the native screen interface 418 on the screen 424. For example, a standard notification for a detected event regarding a fire alert may be “ALERT: FIRE—Vacate the premise immediately!!”. In some embodiments, the controller 414 may be configured to alter a time period for which the notification is displayed on the screen 424 by the native screen interface 418. For example, if the user has indicated his or her preference to view the notification for not more than five seconds, then a time for which a notification is displayed may be altered accordingly by the controller 414.

In some embodiments, the controller 414 may be configured to adjust a sensitivity of the at least one sensor in sensing the attribute in the proximity of the user. The sensitivity of the sensor may be adjusted to an optimum level. It is understood that a high level of sensitivity may result in detection of unwanted or minor activities occurring in the proximity of the user. For example, ruffling of leaves of a tree nearby may be detected as a sound event if the sensitivity of the acoustic sensor is adjusted to a high level. In another example embodiment, a low level of sensitivity may result in failure in detection of critical events. For example, if sensitivity of a smoke detector sensor is adjusted to a low level, the smoke detector sensor may fail to detect a fire event until the fire spreads to a level causing loss to person and property. Accordingly, the sensitivity of the sensors may be tuned appropriately based on user input and active learning by the controller 414 to generate accurate notifications for the user.

An example notification displayed to the user is further explained with reference to FIG. 5.

FIG. 5 shows a representation of an example notification 502 provided to a user engaged in viewing content displayed on a screen 504 of an electronic device 506, in accordance with an example embodiment. The notification 502 may be overlaid on at least a portion of the screen 504 as shown in FIG. 5. The notification 502 includes an alert message stating “A person has moved towards you and is at a distance of three feet from the screen”. On viewing the notification 502, the user may be alerted of a presence of the person, and may choose to refrain from performing confidential activities on the electronic device 506 such as entering passwords, personal identification number (PIN), and the like, which can also be viewed by the person.

The notification 502 may also include additional information. For example, some notifications may be configured to include information, such as a location of the person or the object, a distance of the person or the object from the user, the movement of the person or the object, a size of the moving person or the moving object, a speed of the movement, an acceleration of the movement, a direction of the movement, one or more images or video capturing the movement, and the like. The user may take appropriate action on being alerted of the occurrence of the event in real-time.

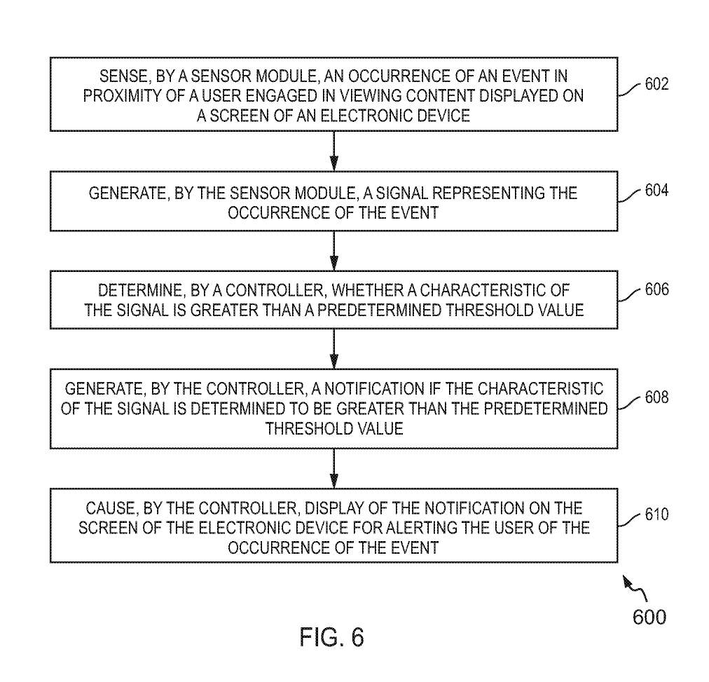

A method for facilitating real-time detection and notification of events is explained with reference to FIG. 6.

FIG. 6 is a flow diagram of an example method 600 for facilitating real-time detection and notification of events, in accordance with an example embodiment. The method 600 depicted in the flow diagram may be executed by, for example, the system 200 explained with reference to FIG. 2. Operations of the flowchart, and combinations of operation in the flowchart, may be implemented by, for example, hardware, firmware, a processor, circuitry and/or a different device associated with the execution of software that includes one or more computer program instructions. The operations of the method 600 are described herein with help of the system 200. It is noted that the operations of the method 600 can be described and/or practiced by using a system other than the system 200. The method 600 starts at operation 602.

At operation 602 of the method 600, an occurrence of an event in proximity of a user engaged in viewing content displayed on a screen of an electronic device is sensed by a sensor module, such as the sensor module 202 explained with reference to FIG. 2. The term ‘proximity’, as explained with reference to FIG. 1, refers to immediate surroundings of the user. For example, a change within a radius of few meters (for example up to five meters radius from a current location of the user) may be construed to be in proximity of the user. Similarly, the term ‘event’, as explained with reference to FIG. 1, refers to a change in the immediate surroundings. For example, if there is movement behind the user or if there is a change in lighting beyond an acceptable range or if there is an object approaching the user, then such observation of a change from a reference position (for example, from a time the user has started viewing the content on the screen) is construed as occurrence of an event. To sense the occurrence of the event in the proximity of the user, the sensor module may include one or more sensors. Each sensor may be configured to sense an attribute in the proximity of the user. For example, the sensor module may include a motion sensor to sense an attribute ‘motion’ in the proximity of the user. More specifically, the motion sensor may be configured to sense movement of an object or a person in proximity of the user. In an illustrative example, the motion sensor may be embodied as an Infrared (IR) motion sensor. In some embodiments, the sensor module may include one or more sensors from among a motion sensor, a light sensor, a temperature sensor, a smoke detection sensor, a pressure sensor, an acoustic sensor, an image sensor, a humidity sensor, and a chemical sensor. Various attributes, such as change in temperature, ambient lighting, sound (or ambient noise), pressure, imagery etc. may be sensed in the proximity of the user.

At operation 604 of the method 600, a signal representing the occurrence of the event is generated by the sensor module. In at least one example embodiment, the sensor module is capable of generating an analog signal representing the event. The sensor module may further be configured to convert the analog signal to a digital signal representing the occurrence of the event. In an embodiment, to represent the occurrence of the event digitally, a characteristic of the digital signal may be modulated appropriately. For example, a characteristic of the digital signal such as a frequency of the digital signal or pulse-width duration of the digital signal may be adjusted so as to represent the occurrence of the event. The digital signal may then be transmitted by the sensor module to the controller.

At operation 606 of the method 600, it is determined whether a characteristic of the signal is greater than a predetermined threshold value by a controller, such as the controller 204 explained with reference to FIG. 2. For example, if a frequency of the received signal is greater than a predetermined threshold frequency value or if the pulse-width duration is greater than a predetermined threshold pulse-width duration value, then the controller may be configured to determine that the characteristic of the signal is greater than the predetermined threshold value.

At operation 608 of the method 600, a notification is generated by the controller if the characteristic of the signal is determined to be greater than the predetermined threshold value. At operation 610 of the method 600, a display of the notification on the screen of the electronic device is caused by the controller to alert the user of the occurrence of an event. The generation and display of the notification may be performed as explained with reference to FIGS. 2 to 5 and is not explained again herein.

The disclosed method 600 or one or more operations of the method 600 may be implemented using software, including computer-executable instructions stored on one or more computer-readable media e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

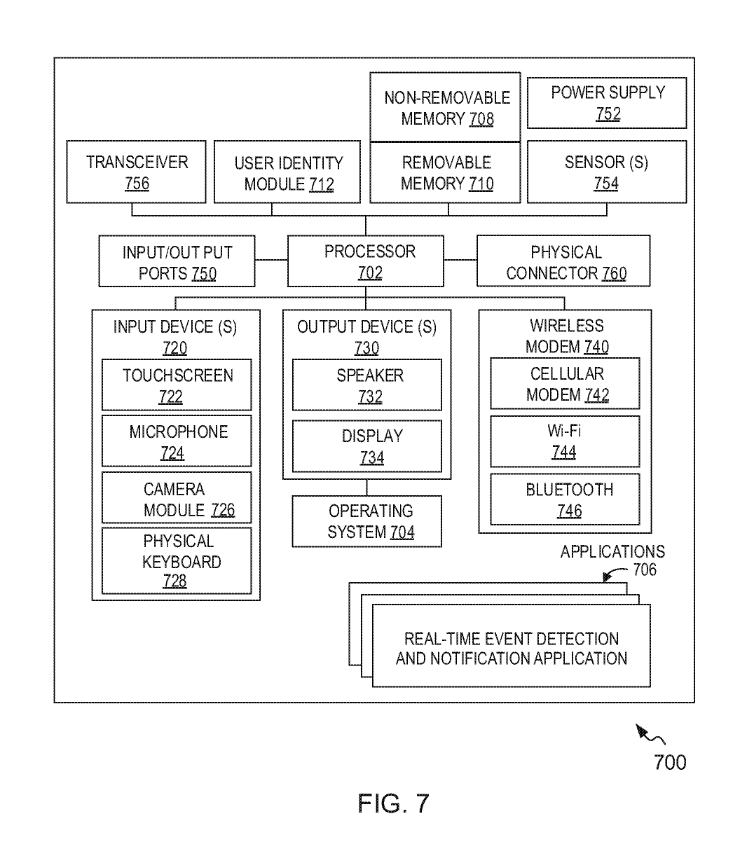

Referring now to FIG. 7, a schematic block diagram of an electronic device 700 is shown that is capable of implementing embodiments of techniques for facilitating real-time detection and notification of events as described herein. It is noted that the electronic device 700 as illustrated and hereinafter described is merely illustrative of one type of device and should not be taken to limit the scope of the embodiments. As such, it should be appreciated that at least some of the components described below in connection with the electronic device 700 may be optional and thus in an example embodiment may include more, less or different components than those described in connection with the example embodiment of FIG. 7. As such, among other examples, the electronic device 700 could be any of device from among fixed electronic devices, such as desktop computers and electronic kiosks, to mobile electronic devices, such as for example, personal digital assistants (PDAs), mobile televisions, cellular phones, tablet computers, laptops, mobile computers or any combination of the aforementioned, and other types of communication or multimedia devices.

The illustrated electronic device 700 includes a controller or a processor 702 (e.g., a signal processor, microprocessor, ASIC, or other control and processing logic circuitry) for performing tasks such as signal coding, data processing, image processing, input/output processing, power control, and/or other functions. An operating system 704 controls the allocation and usage of the components of the electronic device 700 and support for one or more applications programs (see, applications 706), such as a real-time event detection and notification application, that implements one or more of the innovative features described herein. In addition to real-time event detection and notification application, the applications 706 may include common mobile computing applications (e.g., telephony applications, email applications, calendars, contact managers, web browsers, messaging applications) or any other computing application. The real-time event detection and notification application, in at least one example embodiment, may be configured to provide logic to one or more sensors for sensing occurrence of events in proximity of the user. The real-time event detection and notification application may also include logic for processing a signal representing an occurrence of an event and determining whether a notification alerting the user needs to be generated or not. If it determined that a notification needs to be generated, then the real-time event detection and notification application may also be configured to generate an appropriate notification and cause display of the notification to alert the user of the occurrence of the event.

The illustrated electronic device 700 includes one or more memory components, for example, a non-removable memory 708 and/or removable memory 710. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the applications 706. Examples of data can include web pages, text, images, sound files, image data, video data, or other data sets to be sent to and/or received from one or more network servers or other devices via one or more wired or wireless networks. The electronic device 700 may further include a user identity module (UIM) 712. The UIM 712 may be a memory device having a processor built in. The UIM 712 may include, for example, a SIM, a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA).

The electronic device 700 can support one or more input devices 720 and one or more output devices 730. Examples of the input devices 720 may include, but are not limited to, a touch screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video image frames) and a physical keyboard 728. Examples of the output devices 730 may include, but are not limited to a speaker 732 and a display 734. Other possible output devices (not shown) can include piezoelectric or other haptic output devices. Some devices can serve more than one input/output function. For example, the touch screen 722 and the display 734 can be combined into a single input/output device.

In an embodiment, the camera module 726 may include a digital camera capable of facilitating image/video capture. In some implementations, the camera module 726 may include two or more cameras, for example, a front camera and a rear camera positioned on two sides of the electronic device 700. As such, the camera module 726 includes all hardware, such as a lens or other optical component(s), and software for capturing images and/or creating a video stream from a captured video. Alternatively, the camera module 726 may include the hardware needed to view the video, while a memory device of the electronic device 700 stores instructions for execution by the processor 702 in the form of software to create a video stream from a captured video. In an example embodiment, the camera module 726 may further include a processing element such as a co-processor, which assists the processor 702 in processing image frame data and an encoder and/or decoder for compressing and/or decompressing image data. In an embodiment, the camera module 726 may provide live image data (viewfinder image data) to the display 734.

A wireless modem 740 can be coupled to one or more antennas (not shown in FIG. 6) and can support two-way communications between the processor 702 and external devices, as is well known in the art. For example, the communication may include provisioning notifications to the user and the like. The wireless modem 740 is shown generically and can include, for example, a cellular modem 742 for communicating at long range with the mobile communication network, a Wi-Fi-compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the mobile device and a public switched telephone network (PSTN).

The electronic device 700 can further include one or more input/output ports 750, a power supply 752, one or more sensors 754 for example, a motion sensor, a light sensor, a temperature sensor, a smoke detection sensor, a pressure sensor, an acoustic sensor, an image sensor and a chemical sensor, a transceiver 756 (for wirelessly transmitting analog or digital signals) and/or a physical connector 760, which can be a USB port, IEEE 1394 (FireWire) port, and/or RS-232 port. The illustrated components are not required or all-inclusive, as any of the components shown can be deleted and other components can be added.

Various example embodiments offer, among other benefits, techniques for efficient detection and notification of events occurring in real-time in the proximity of the user. The methods and systems disclosed herein enable the user to view the notifications of the events as an overlay on the screen, thereby ensuring a prompt awareness of the occurring event for the user. Further, notifying a user as described herein avoids use of additional hardware, such as surveillance cameras or even security personnel to intimate the user of an event occurring in proximity of the user. Displaying the notification in substantially real-time enables the user to take appropriate action in a timely manner, which may especially be important, if the event occurring is dangerous or disruptive in nature.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the system 200, the sensor module 202, the controller 204, the storage module 206 and the display module 208 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIG. 6). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A system comprising:
a sensor module configured to sense an occurrence of an event in proximity of a user engaged in viewing content displayed on a screen of an electronic device, the sensor module capable of generating a signal representing the occurrence of the event;
a controller communicably coupled with the sensor module, the controller configured to generate a notification if a predefined criterion related to the signal is satisfied; and
a display module communicably coupled with the controller, the display module configured to overlay the notification on the screen of the electronic device to alert the user of the occurrence of the event.

2. The system as claimed in claim 1, wherein the electronic device comprises the controller and the display module.

3. The system as claimed in claim 2, wherein the electronic device comprises the sensor module.

4. The system as claimed in claim 1, wherein the sensor module comprises:
at least one sensor configured to sense an attribute in the proximity of the user, the sensing of the attribute indicative of the occurrence of the event, the at least one sensor configured to generate an analog signal representing the occurrence of the event.

5. The system as claimed in claim 4, wherein a sensor from among the at least one sensor is a motion sensor configured to sense movement in the proximity of the user.

6. The system as claimed in claim 4, wherein the at least one sensor comprises one or more sensors from among a motion sensor, a light sensor, a temperature sensor, a smoke detection sensor, a pressure sensor, an acoustic sensor, an image sensor, a humidity sensor and a chemical sensor.

7. The system as claimed in claim 4, wherein the controller is configured to perform at least one of:
adjust a sensitivity of the at least one sensor in sensing the attribute in the proximity of the user; and
alter a time period for which the notification is displayed on the screen of the electronic device by the display module.

8. The system as claimed in claim 4, further comprising:
a signal convertor configured to convert the analog signal to a digital signal representing the occurrence of the event.

9. The system as claimed in claim 8, further comprising:
a storage module communicably associated with the controller, the storage module configured to store logic for comparing a characteristic of the digital signal with a predetermined threshold value.

10. The system as claimed in claim 9, wherein the characteristic of the digital signal corresponds to one of frequency of the signal and pulse-width duration of the signal.

11. The system as claimed in claim 9, wherein the predefined criterion corresponds to the characteristic of the digital signal exceeding the predetermined threshold value.

12. The system as claimed in claim 1, wherein the event comprises one of a movement of a person or an object in the proximity of the user, a change in one of ambient lighting and ambient noise in the proximity of the user and an environmental change occurring in the proximity of the user.

13. The system as claimed in claim 1, wherein the notification is configured as one of a text notification, a voice notification, an image-based notification, a video notification and a multimedia notification.

14. The system as claimed in claim 1, wherein the notification comprises information related to at least one of a location of a person or an object moving in the proximity of the user, a distance of the person or the object from the user, a size of the moving person or the moving object, a speed of movement of the moving person or the moving object, an acceleration associated with the movement and a direction of movement of the moving person or the moving object.

15. A system comprising:
at least one sensor configured to sense an attribute in proximity of a user engaged in viewing content displayed on a screen of an electronic device, the sensing of the attribute indicative of an occurrence of an event, the at least one sensor configured to generate an analog signal representing the occurrence of the event;
a signal convertor configured to convert the analog signal to a digital signal representing the occurrence of the event;
a controller configured to generate a notification if a characteristic of the digital signal exceeds a predetermined threshold value; and
a display module configured to overlay the notification on a display screen to alert the user of the occurrence of the event.

16. The system as claimed in claim 15, wherein the display screen corresponds to the screen of the electronic device.

17. The system as claimed in claim 15, wherein a sensor from among the at least one sensor is a motion sensor configured to sense movement in the proximity of the user.

18. The system as claimed in claim 15, wherein the characteristic of the digital signal corresponds to one of frequency of the signal and pulse-width duration of the signal.

19. The system as claimed in claim 15, wherein the notification is configured as one of a text notification, a voice notification, an image-based notification, a video notification and a multimedia notification.

20. The system as claimed in claim 15, wherein the notification comprises information related to at least one of a location of a person or an object moving in the proximity of the user, a distance of the person or the object from the user, a size of the moving person or the moving object, a speed of movement of the moving person or the moving object, an acceleration associated with the movement and a direction of movement of the moving person or the moving object.

21. A method comprising:
sensing, by a sensor module, an occurrence of an event in proximity of a user engaged in viewing content displayed on a screen of an electronic device;
generating, by the sensor module, a signal representing the occurrence of the event;
determining, by a controller communicably coupled with the sensor module, whether a characteristic of the signal is greater than a predetermined threshold value;
generating, by the controller, a notification if the characteristic of the signal is determined to be greater than the predetermined threshold value; and
causing, by the controller, display of the notification on the screen of the electronic device to alert the user of the occurrence of the event.

22. The method as claimed in claim 21, wherein the occurrence of the event corresponds to a movement of a person or an object in the proximity of the user.

23. The method as claimed in claim 21, wherein the characteristic of the signal corresponds to one of a frequency of the signal and pulse-width duration of the signal.

24. The method as claimed in claim 21, wherein the notification is configured as one of a text notification, a voice notification, an image-based notification, a video notification and a multimedia notification.

25. The method as claimed in claim 21, wherein the notification comprises information related to at least one of a location of a person or an object moving in the proximity of the user, a distance of the person or the object from the user, a size of the moving person or the moving object, a speed of movement of the moving person or the moving object, an acceleration associated with the movement and a direction of movement of the moving person or the moving object.
